(19) United States
(12) Patent Application Publication
(10) Pub. No.: US 2008/0130402 A1
(43) Pub. Date: Jun. 5, 2008

(54) MICROCHANNEL CHIP AND CONVERGING DEVICE

(76) Inventors: Hideyuki KARAKI, Minami-Ashigara-shi (JP); Yoshihiro Sawayashiki, Minami-Ashigara-shi (JP); Akira Wakabayashi, Minami-Ashigara-shi (JP); Yoshihide Iwaki, Ashigarakami-gun (JP)

Correspondence Address: BIRCH STEWART KOLASCH & BIRCH, PO BOX 747, FALLS CHURCH, VA, 22040-0747, US

(21) Appl. No.: 11/940,939

(22) Filed: Nov. 15, 2007

(30) Foreign Application Priority Data
Nov. 22, 2006 (JP) P2006-316127

(51) Int. Cl. B01F 15/02; B01F 15/00

(52) U.S. Cl. 366/142; 366/163.2

(57) ABSTRACT

A microchannel chip, includes: a first channel where a first liquid is transported from one end side to an opposite end side; a port section to which a second liquid is supplied from outside for accumulating the second liquid; and a second channel connecting the first channel and the port section through a first opening provided in a side of the first channel and a second opening provided in the port section, wherein the second channel checks flowing out of the second liquid accumulated in the port section to the first channel by a Laplace pressure valve until the first liquid arrives at the first opening, and the second channel converges the second liquid into the first liquid after the first liquid reaches the first opening, and a converging device using the same.

### BACKGROUND OF THE INVENTION

1. Field of the Invention

This invention relates to a microchannel chip for mixing two liquids and a converging device capable of mixing a predetermined quantity of a second liquid with a predetermined quantity of a first liquid without involving an air bubble.

2. Description of the Related Art

To mix a second liquid with a first liquid, first, the second liquid needs to be converged with the first liquid. For example, using a channel 1 shaped like a letter Y shown in FIG. 10, the first liquid is allowed to flow into a first branch channel 2 and the second liquid is allowed to flow into a second branch channel 3, whereby the first liquid and the second liquid can be mixed with each other in a converging channel 4.

In the channel 1 shown in FIG. 10, however, when the second liquid is allowed to flow into the second branch channel 3 after the first liquid is allowed to flow into the converging channel 4 from the first branch channel 2 as shown in FIG. 11A, an air bubble 5 is entered between the leading face of the second liquid in the second branch channel 3 and the first liquid as shown in FIG. 11B and a defective condition that the air bubble 5 mixes in the post-mixed two liquids as shown in FIG. 11C occurs.

If the supply start timings of the first liquid and the second liquid are controlled so that the timing at which the first liquid arrives at the converging channel 4 from the first branch channel 2 and the timing at which the second liquid arrives at the converging channel 4 from the second branch channel 3 become the same, mixing of an air bubble does not occur. In fact, however, it is difficult to control the arrival timings as the same timing and mixing of an air bubble cannot be circumvented.

Then, hitherto a Laplace pressure valve has been used as shown in JP-A-2004-157097, JP-A-2004-225912 and JP-A-2002-527250. When the Laplace pressure valve is described using the channel 1 in FIG. 10, it refers to a phenomenon in which when the second liquid is introduced into the second branch channel 3, the second liquid is checked due to a Laplace pressure difference in the connection end face portion to the converging channel 4 if the capillary force of the second branch channel 3 is previously made large as compared with the capillary force of the first branch channel 2 and that of the converging channel 4 (for example, the capillary force can be made large by thinning the pipe line).

In this state, when the first liquid is allowed to flow into the converging channel 4 from the first branch channel 2 and reaches the connection end face portion and wets the end face of the second liquid, the Laplace pressure valve is “opened,” preventing an air bubble from being sandwiched between the first liquid and the second liquid when the liquids mix.

### SUMMARY OF THE INVENTION

To mix two liquids with each other, mixing of an air bubble can be circumvented by using the Laplace pressure valve. However, each of the microchannel chips described in JP-A-2004-225912 and JP-A-2002-527250 has a basic configuration wherein one liquid is branched into two channels and one is checked by the Laplace pressure valve before they are mixed. Therefore, to mix two liquids according to this method, although two liquids of continuous flows can be converged, it is difficult to mix two liquids each having a given quantity. Withstand pressure p of the Laplace pressure valve generally is represented as p=2 γ cos θ/r. To mix two liquids each having a given quantity with each other, it is necessary to check liquid A of a given quantity by the Laplace pressure valve and transport liquid B of a given quantity by air pressure or a centrifugal force. At this time, if the same pressure also acts on the Laplace pressure valve and exceeds the withstand pressure of the valve, the valve is opened before the liquids mix, and an air layer is produced between the liquids A and B and the liquids cannot mix. In the microchannel chip in JP-A-2004-157097, liquid is handled quantitatively and thus an atmospheric release part is provided in a channel, it is feared that some of the liquid transported under pressure may leak out from the atmospheric release part to the outside, and it is difficult to stably mix two liquids each having a fixed quantity with each other.

It is an object of the invention to provide a microchannel chip for mixing two liquids and a converging device capable of stably mixing two liquids each having a given quantity with each other as mixing of an air bubble is circumvented.

(1) A microchannel chip, comprising:

a first channel where a first liquid of a first quantity is transported from one end side to an opposite end side;

a port section having a capillary force smaller than a capillary force of the first channel, the port section to which a second liquid of a given quantity is supplied from outside for accumulating the second liquid; and

a second channel having a capillary force larger than the capillary force of the first channel, the second channel connecting the first channel and the port section through a first opening provided in a side of the first channel and a second opening provided in the port section,

wherein the second channel checks flowing out of the second liquid accumulated in the port section to the first channel by a Laplace pressure valve until the first liquid arrives at the first opening, and

the second channel converges the second liquid of a second quantity resulting from subtracting a volume of the second channel from the given quantity into the first liquid of the first quantity after the first liquid reaches the first opening.

(2) The microchannel chip as described in (1) above,

wherein a plurality of pairs of the port sections and the second channels are apposed along the first channel.

(3) A converging device, comprising:

the microchannel chip as described in (1) or (2) above; and

a decompression unit that applies a decompression force to the opposite end side of the first channel for transporting the first liquid under decompression to the opposite end side.

(4) A converging device, comprising:

the microchannel chip as described in (1) above;

a decompression unit that applies a decompression force to the opposite end side of the first channel for transporting the first liquid under decompression to the opposite end side; and

a valve unit provided between the decompression unit and the port section, the valve unit allowing the decompression unit to also apply the decompression force to the port section until the first liquid arrives at the first opening, and releasing the port section into atmosphere after the first liquid arrives at the first opening.

(5) A converging device, comprising:

the microchannel chip as described in (2) above;

a decompression unit that applies a decompression force to the opposite end side of the first channel for transporting the first liquid under decompression to the opposite end side; and

a plurality of valve units each provided between the decompression unit and each of the port sections, the plurality of valve units each allowing the decompression unit to also apply the decompression force to the corresponding port section until the first liquid arrives at the first opening for each of the pairs, and releasing the corresponding port section into atmosphere after the first liquid arrives at the first opening.

(6) A converging device, comprising:

the microchannel chip as described in (1) above;

a compression and decompression unit that compresses the first liquid from the one end side for transporting the first liquid under compression until the first liquid arrives at the first opening, stops the compression after the first liquid arrives at the first opening, and applies a decompression force to the opposite end side for transporting the first liquid under decompression; and

a valve unit that performs route switching of the compression force and the decompression force made by the compression and decompression unit.

(7) The converging device as described in any of (4) to (6) above, further comprising:

a sensor that detects the first liquid arriving at the first opening.

(8) The converging device as described in (7) above,

wherein the valve unit is subjected to automatic switching control according to a detection signal of the sensor.

The invention makes it possible to stably mix two liquids each having a given quantity with each other as mixing of an air bubble is circumvented.

### BRIEF DESCRIPTION OF THE DRAWINGS

FIG. 1 is a top view of a microchannel chip for mixing two liquids according to a first embodiment of the invention;

FIG. 2 is a sectional view taken on line II-II in FIG. 1;

FIG. 3 is a sectional view taken on line III-III in FIG. 1;

FIGS. 4A and 4B are drawings to show the initial state when two liquids are converged with each other in the microchannel chip for mixing two liquids according to the embodiment of the invention shown in FIG. 1;

FIGS. 5A to 5C are schematic representations to show the process of converging two liquids from the state in FIGS. 4A and 4B;

FIG. 6 is a drawing of the configuration of a converging device for mixing two liquids according to a second embodiment of the invention;

FIG. 7 is a flowchart to show an operation procedure of the converging device for mixing two liquids shown in FIG. 6;

FIG. 8 is a drawing of the configuration of a converging device for mixing two liquids according to a third embodiment of the invention;

FIG. 9 is a flowchart to show an operation procedure of the converging device for mixing two liquids shown in FIG. 8;

FIG. 10 is a schematic representation of channels where two liquids are converged with each other; and

FIGS. 11A to 11C are drawings of a converging process for mixing two liquids using the channels in FIG. 10.

### DETAILED DESCRIPTION OF THE INVENTION

An embodiment of the invention will be discussed with reference to the accompanying drawings.

### First Embodiment

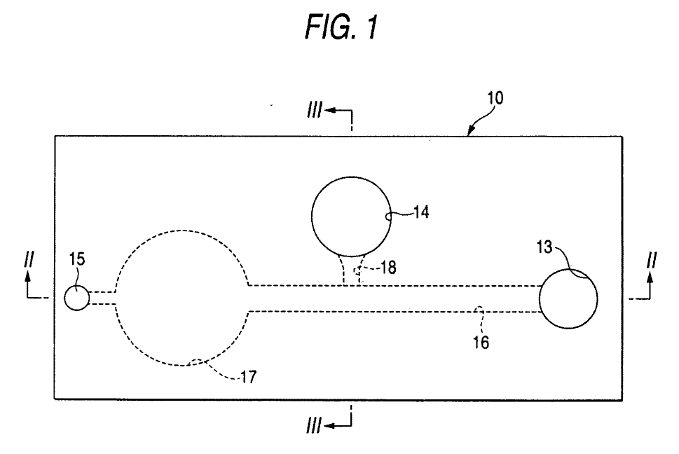

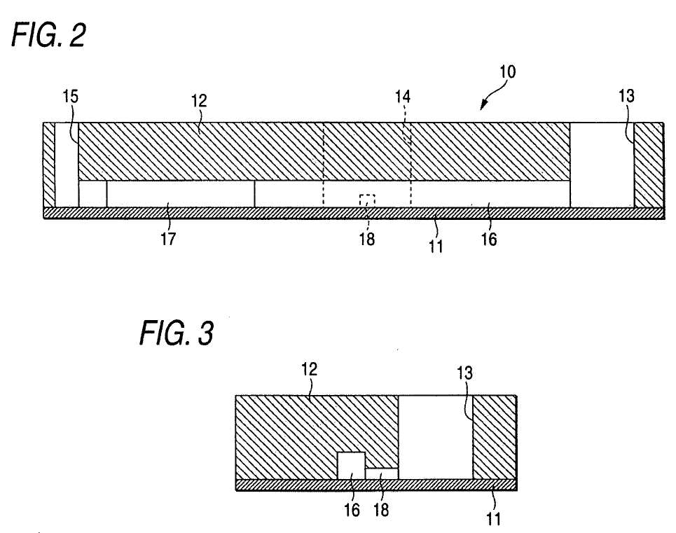

FIG. 1 is a top view of a microchannel chip for mixing two liquids according to an embodiment of the invention, FIG. 2 is a sectional view taken on line II-II in FIG. 1, and FIG. 3 is a sectional view taken on line III-III in FIG. 1.

A microchannel chip for mixing two liquids 10 according to the embodiment has a resin material 12 of a polymer, etc., deposited on a rectangular substrate 11 by injection molding, etc. At this time, the following port sections and channels are formed.

The microchannel chip for mixing two liquids 10 in the example shown in the figure is provided with three port sections 13, 14, and 15. The first port section 13 is provided in the right end portion of the chip 10, the second port section 14 is provided at the center to the top side of the chip 10, and the third port section 15 is provided in the left end portion of the chip 10. Each of the port sections 13, 14, and 15 is a columnar hole having an opening in the top face of the chip 10 and a bottom reaching the substrate 11.

The first port section 13 and the third port section 15 are communicated with each other by a first channel 16 which is formed on the substrate 11 and is rectangular in cross section. A part of the first channel 16 to the third port section 15 is formed as a circle expanded on the top view (circular channel 17) and post-converged two liquids (described later) are accumulated in the circular channel 17. The height of the circular channel 17 is the same as that of the first channel 16.

The second port section 14 and the first channel 16 are communicated with each other by a second channel 18 which is formed on the substrate 11, is narrow and short, and is rectangular in cross section. The capillary force of the second channel 18 is formed larger than that of the first channel 16. In the example shown in the figure, the equivalent radius of the rectangular shape in the cross section of the second channel 18 is formed smaller than the equivalent radius of the first channel 16. Between the second port section 14 and the first channel 16 communicated by the second channel 19, the capillary force of the second port section 14 is formed smaller than that of the first channel 16.

That is, the microchannel chip for mixing two liquids 10 of the embodiment is formed so that the magnitude relation among the capillary forces becomes as follows:

[Second channel 18]>[first channel 16]>[second port section 14]

The capillary force is represented by pressure P and P=(2·γ·cos θ)/r where γ is surface tension of liquid [mN/m], θ is contact angle between liquid and channel [deg], and r is equivalent radius of channel.

The equivalent radius is a half value of the equivalent diameter and the equivalent diameter has the same meaning as the term used generally in the mechanical engineering field. Assuming an equivalent circular pipe for a channel which is any shape in cross section (piping), the diameter of the equivalent circular pipe is referred to as “equivalent diameter” and equivalent diameter deq is defined as deq=4K/L where K is the cross-sectional area of piping and L is the perimeter of piping.

To control the capillary forces, the diameters of the channels, etc., are adjusted at a low cost at the manufacturing time of the chip; adjustment can also be made by performing hydrophilic or water-repellent control in such a manner that the inner faces of channels are subjected to plasma treatment when the chip is manufactured.

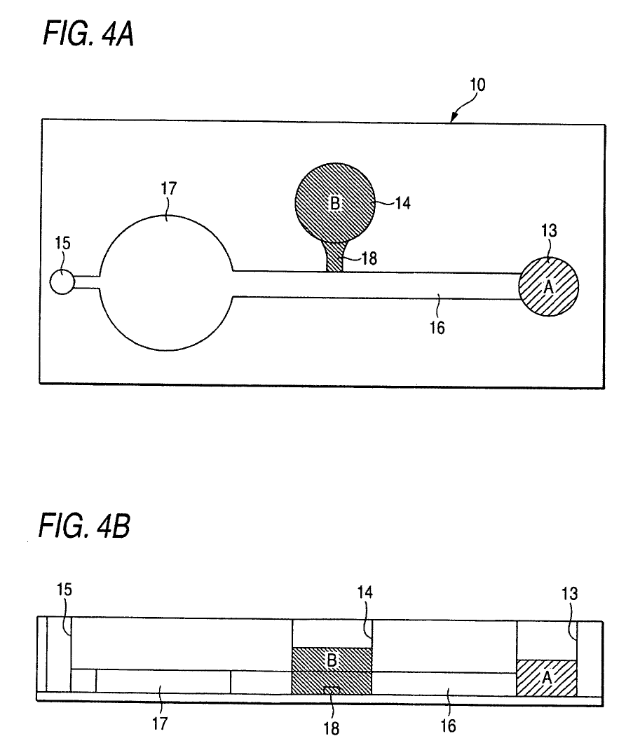

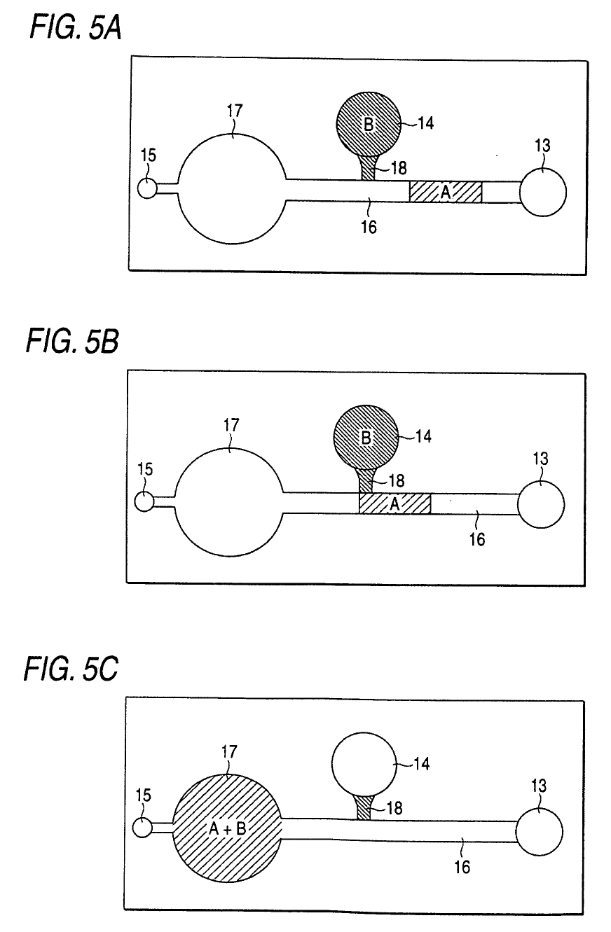

Two-liquid mixing will be discussed below with FIGS. 4A to 5C: First, a liquid sample A of a predetermined quantity is entered in the first port section 13 and a liquid sample B of a predetermined quantity is entered in the second port section 14. For example, the liquid sample A of a predetermined quantity treated in the preceding step of two-liquid converging treatment performed in the microchannel chip for mixing two liquids 10 may be automatically supplied to the first port section 13 by a pouring device or the liquid sample A of a predetermined quantity may be manually poured into the first port section 13. A similar description also applies to a liquid sample B.

When the liquid sample B of a predetermined quantity is supplied to the second port section 14, the liquid sample B proceeds into the second channel 18 by the capillary force and is checked on the opening end face of the second channel 18 on the side of the first channel 16 by a Laplace pressure valve.

Next, when the third port section 15 is decompressed by a decompression unit connected to the third port section 15, the liquid sample A in the first port section 13 is sucked into the first channel 16 and proceeds in the first channel 16 in the direction of the circular channel 17, as shown in FIG. 5A.

When the liquid sample A proceeding in the first channel 16 arrives at the opening end face of the second channel 18 (FIG. 5B), the Laplace pressure valve is opened.

After this, decompression application to the third port section 15 is continued, whereby the liquid sample B in the second port section 14 flows into the first channel 16 without performing any special operation because of the magnitude relation between the capillary force of the second port section 14 and that of the first channel 16 (second port section 14<first channel 16) and converges into the liquid sample A without involving any air bubble.

Further, when decompression application to the third port section 15 is continued, the sample resulting from the liquid sample B converging into the liquid sample A proceeds to the circular channel 17 and is accumulated therein, as shown in FIG. 5C. However, the liquid sample B remains in the second channel 18 because of the magnitude relation between the capillary force of the second channel 18 and that of the first channel 16 (first channel 16<second channel 18).

Therefore, to use the microchannel chip for mixing two liquids 10 of the embodiment, the liquid sample A of the first predetermined quantity supplied to the first port section 13 and the liquid sample B of a second predetermined quantity resulting from subtracting the volume of the second channel 18 from the given quantity supplied to the second port section 14 are converged with each other.

The converging liquids A and B flowing into the circular channel 17 are mixed uniformly in the later mixing step.

The embodiment described above holds true only if the magnitude relation between the withstand pressure of the Laplace pressure valve of the liquid sample B and pressure for transporting the liquid sample A is |withstand pressure of Laplace pressure valve|>|decompression transport pressure of liquid sample A|. If the relation does not hold true, the valve is opened before the liquids converge, and an air layer is formed between the two liquids and the liquids cannot converge.

### Second Embodiment

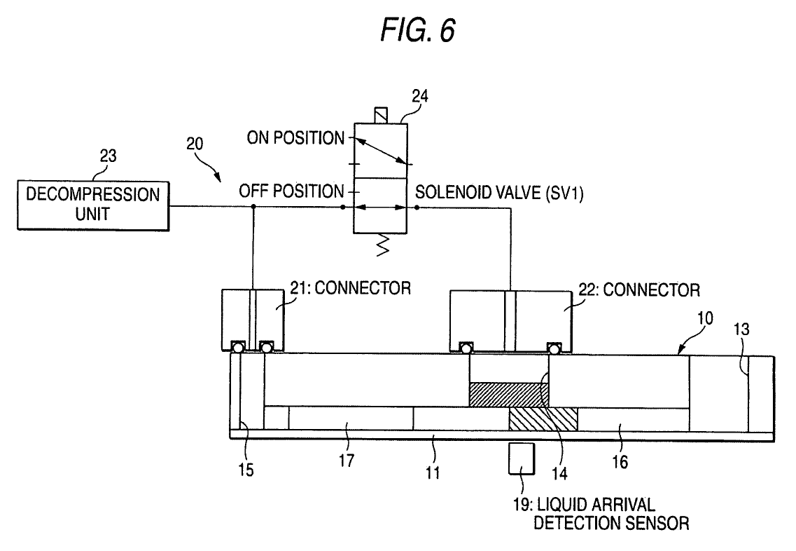

FIG. 6 is a configuration drawing to show an embodiment of a converging device for mixing two liquids of the invention. The converging device for mixing two liquids of the embodiment includes the microchannel chip for mixing two liquids 10 previously described with reference to FIGS. 1 to 5C, a liquid arrival detection sensor 19, and a liquid delivery device 20.

The liquid arrival detection sensor 19 is provided in the proximity of the opening end of the second channel 18 on the side of the first channel 16 and is a sensor for detecting that the liquid sample A proceeding in the first channel 16 arrives at the opening end of the second channel 18; for example, it is implemented as a reflection fiber sensor.

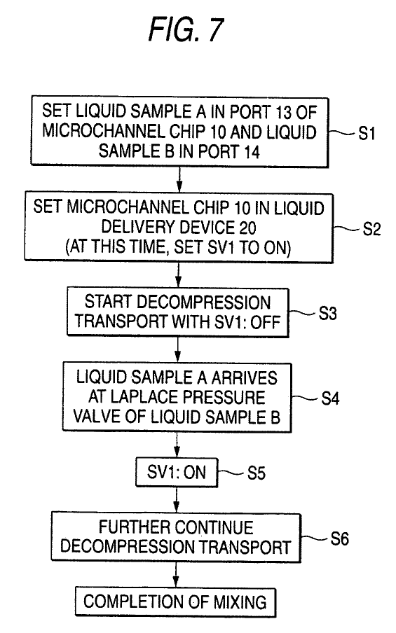

The liquid delivery device 20 includes a connector 21 connected to the opening of the third port section 15, a connector 22 connected to the opening of the second port section 14, a decompression unit 23 connected to the third port section 15 through the connector 21, and a solenoid valve 24 of three ports (also called SV1 in the description with FIGS. 6 and 7) intervened between the decompression unit 23 and the connector 22.

The SV1 has OFF-position and ON-position valve plugs; the OFF-position valve plug connects the second port section 14 to the decompression unit 23 through the connector 22 and the ON-position valve plug releases the second port section 14 into the atmosphere through the connector 22 and closes the connection portion to the decompression unit 23.

FIG. 7 is a flowchart to show an operation procedure of the converging device for mixing two liquids shown in FIG. 6. First, the liquid sample A of a first predetermined quantity is set in the first port section 13 and the liquid sample B of a given quantity is set in the second port section 14 (step S1). Accordingly, the liquid sample B proceeds into the second channel 18 and is stopped by the Laplace pressure valve (state in FIGS. 4A and 4B).

Next, the sensor 19 and the connectors of the liquid delivery device 20 are attached to the microchannel chip for mixing two liquids 10 (step S2). At this time, the solenoid valve SV1 is previously set to ON. If the connectors are connected to the chip 10 with the solenoid valve SV1 OFF, when an elastic member (O ring, etc.,) of each connector becomes deformed, it is feared that air between the connector and the liquid level of the liquid sample B may be compressed and the Laplace pressure valve may be opened by the compression pressure. Thus, SV1 is previously set to ON.

Next, the solenoid valve SV1 is set to OFF and the decompression unit 23 is caused to start decompression (step S3). Accordingly, the second port section 14 and the third port section 15 are communicated with each other and the same decompression pressure is applied to both the port sections 14 and 15 and the liquid sample A proceeds in the first channel 16 as shown in FIG. 5A.

Since the same decompression pressure is applied to both the port sections 14 and 15, the front pressure (opening end pressure on the side of the first channel) and the rear pressure (application pressure of the second port section 14) of the Laplace pressure valve become the same and the fear of allowing the liquid sample B to leak from the Laplace pressure valve to the first channel 16 is eliminated.

When the sensor 19 detects the liquid sample A arriving at the Laplace pressure valve (state in FIG. 5B) at the next step S4, the solenoid valve SV1 is automatically set to ON at step S5.

As the liquid sample A arrives at the Laplace pressure valve, the Laplace pressure valve is opened and at this time as the SV1 is ON, the pressure of the second port section 14 is released into the atmosphere. Accordingly, preparations for starting convergence of the liquid sample A and the liquid sample B are complete.

When decompression transport is further continued at step S6, the two liquids A and B converged without involving any air bubble flow into the circular channel 17 and the mixing is complete.

### Third Embodiment

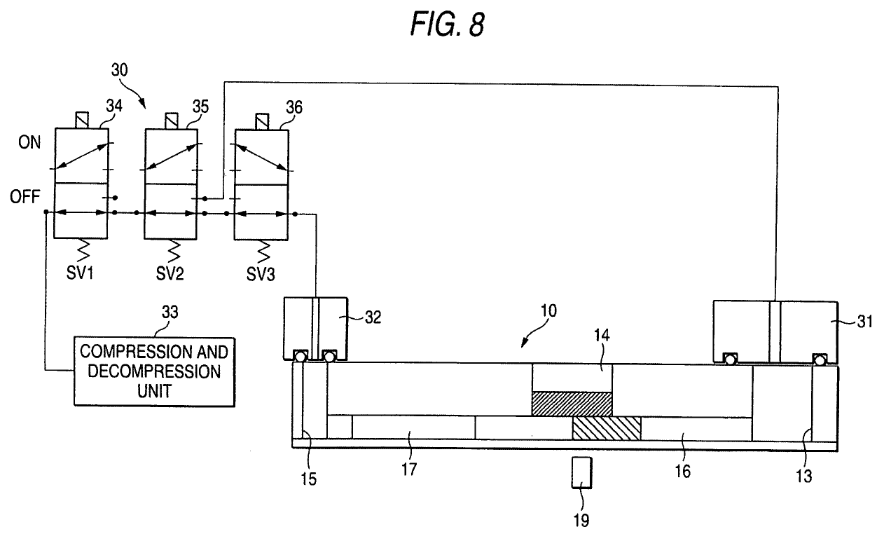

FIG. 8 is a drawing of the configuration of a converging device for mixing two liquids according to another embodiment of the invention. The converging device for mixing two liquids of the embodiment includes the microchannel chip for mixing two liquids 10 previously described with reference to FIG. 1, the liquid arrival detection sensor 19 previously described with reference to FIG. 6, and a liquid delivery device 30.

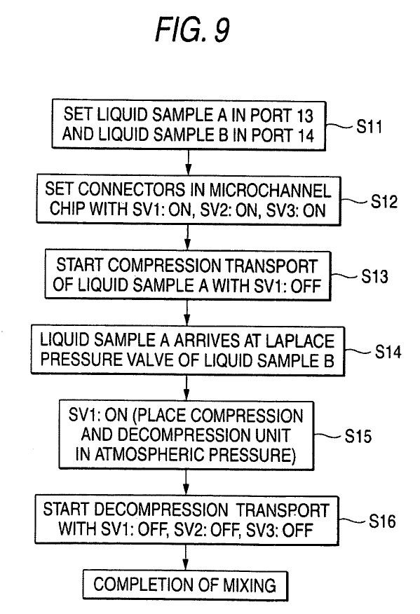

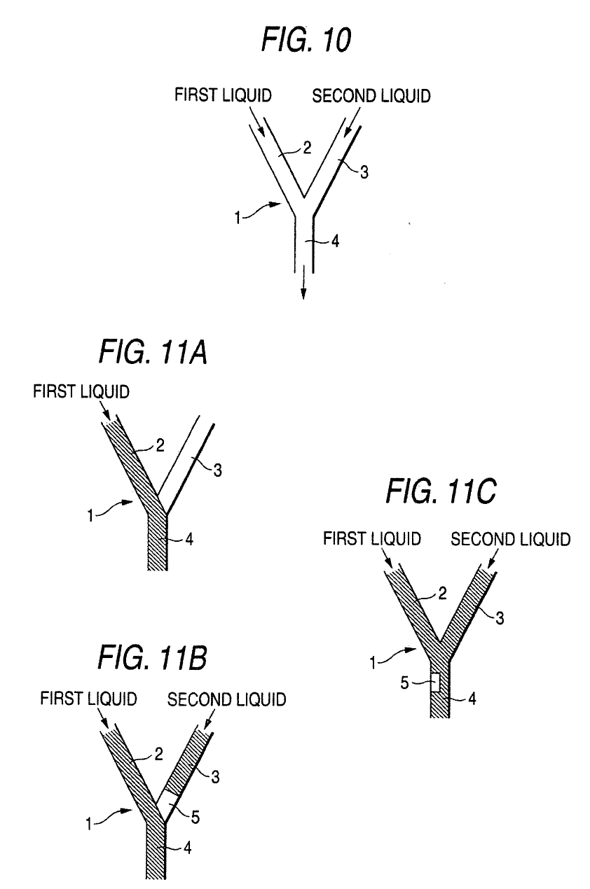

The liquid delivery device 30 includes a connector 31 connected to the opening of the first port section 13, a connector 32 connected to the opening of the third port section 15, a compression and decompression unit 33, and solenoid valves 34 (called SV1 in the description with FIG. 9), 35 (called SV2 in the description with FIG. 9), and 36 (called SV3 in the description with FIG. 9) of three ports for performing the operation described later.

FIG. 9 is a flowchart to show an operation procedure of the converging device for mixing two liquids shown in FIG. 8. First, the sample A of any desired quantity is set in the first port section 13 and the sample B of any desired quantity is set in the second port section 14 (step S11).

The sample may be poured manually or may be poured automatically by a pouring device as in the embodiment described above. The sample B proceeds into the second channel 18 by the capillary force and is stopped the end face facing the first channel 16 by the Laplace pressure valve.

Next, the sensor 19 and the connectors 31 and 32 are attached to the microchannel chip 10 where the samples A and B are set. At this time, the solenoid valves SV1, SV2, and SV3 are set to ON (step S12).

The SV1 is set to OFF at the next step S13. Accordingly, applied pressure from the compression and decompression unit 33 passes through the OFF-position valve plug of the SV1 and the ON-position valve plug of the SV2 and is applied from the connector 31 to the first port section 13. Accordingly, the liquid sample A in the first port section 13 is sent out to the first channel 16. At this time, the downstream side of the liquid sample A, namely, the Laplace pressure valve face of the sample B is under the atmospheric pressure and thus there is no fear of allowing the sample B to leak from the valve.

When the sample A arrives at the Laplace pressure valve and the sensor 19 detects the sample A arriving at the Laplace pressure valve (step S14), then the SV1 is automatically set to ON (step S15). Accordingly, applying the pressure to the first port section 13 is stopped.

Next, all of the SV1, the SV2, and the SV3 are automatically set to OFF and decompression force of the compression and decompression unit 33 is applied to the third port section 15 (step S16). Accordingly, the sample A is transported under decompression through the first channel 16 to the circular channel 17. At this time, the Laplace pressure valve is opened and thus the liquid sample B passed through the second channel 18 starts to converge into the liquid sample A.

After this, without performing any special operation, as the transport under decompression is continued, the liquid sample B in the second port section 14 flows into the first channel 16 without involving any air bubble because of the magnitude relation between the capillary force of the second port section 14 and that of the first channel 16 (second port section 14<first channel 16) and the samples A and B converge.

In the embodiments described above, only one pair of the second port section 14 and the second channel 18 is provided in the first channel and the two-liquid convergence has been described, but a plurality of pairs are provided and are apposed along the first channel 16, whereby it is made possible to execute a plurality of two-liquid convergence in order for mixing three or more liquid samples with each other.

In such a converging device for mixing three or more liquid samples with each other, for example, the valve 24 as shown in FIG. 6 may be provided for each port section and the corresponding port section may be released into the atmospheric pressure each time the first liquid arrives at the Laplace pressure valve.

According to the invention, liquid samples each having a fixed quantity can be well mixed with each other without involving any air bubble, so that the invention is useful for a converging device for mixing liquids and a microchannel chip for mixing liquids.

The entire disclosure of each and every foreign patent application from which the benefit of foreign priority has been claimed in the present application is incorporated herein by reference, as if fully set forth.

What is claimed is:

1. A microchannel chip, comprising:
a first channel where a first liquid of a first quantity is transported from one end side to an opposite end side;
a port section having a capillary force smaller than a capillary force of the first channel, the port section to which a second liquid of a given quantity is supplied from outside for accumulating the second liquid; and
a second channel having a capillary force larger than the capillary force of the first channel, the second channel connecting the first channel and the port section through a first opening provided in a side of the first channel and a second opening provided in the port section,
wherein the second channel checks flowing out of the second liquid accumulated in the port section to the first channel by a Laplace pressure valve until the first liquid arrives at the first opening, and
the second channel converges the second liquid of a second quantity resulting from subtracting a volume of the second channel from the given quantity into the first liquid of the first quantity after the first liquid reaches the first opening.

2. The microchannel chip according to claim 1,
wherein a plurality of pairs of the port sections and the second channels are apposed along the first channel.

3. A converging device, comprising:
the microchannel chip according to claim 1; and
a decompression unit that applies a decompression force to the opposite end side of the first channel for transporting the first liquid under decompression to the opposite end side.

4. A converging device, comprising:
the microchannel chip according to claim 1;
a decompression unit that applies a decompression force to the opposite end side of the first channel for transporting the first liquid under decompression to the opposite end side; and
a valve unit provided between the decompression unit and the port section, the valve unit allowing the decompression unit to also apply the decompression force to the port section until the first liquid arrives at the first opening, and releasing the port section into atmosphere after the first liquid arrives at the first opening.

5. A converging device, comprising:
the microchannel chip according to claim 2;
a decompression unit that applies a decompression force to the opposite end side of the first channel for transporting the first liquid under decompression to the opposite end side; and
a plurality of valve units each provided between the decompression unit and each of the port sections, the plurality of valve units each allowing the decompression unit to also apply the decompression force to the corresponding port section until the first liquid arrives at the first opening for each of the pairs, and releasing the corresponding port section into atmosphere after the first liquid arrives at the first opening.

6. A converging device, comprising:
the microchannel chip according to claim 1;
a compression and decompression unit that compresses the first liquid from the one end side for transporting the first liquid under compression until the first liquid arrives at the first opening, stops the compression after the first liquid arrives at the first opening, and applies a decompression force to the opposite end side for transporting the first liquid under decompression; and
a valve unit that performs route switching of the compression force and the decompression force made by the compression and decompression unit.

7. The converging device according to claim 4, further comprising:
a sensor that detects the first liquid arriving at the first opening.

8. The converging device according to claim 7,
wherein the valve unit is subjected to automatic switching control according to a detection signal of the sensor.
